(19) United States
(12) Patent Application Publication
(10) Pub. No.: US 2025/0164936 A1
(43) Pub. Date: May 22, 2025

(54) ELECTRONIC DEVICE AND ELECTRONIC TIMEPIECE

(71) Applicant: CASIO COMPUTER CO., LTD., Tokyo (JP)

(72) Inventors: Tomoyasu KUROKAWA, Tokyo (JP); Takayuki SATOU, Tokyo (JP)

(73) Assignee: CASIO COMPUTER CO., LTD., Tokyo (JP)

(21) Appl. No.: 18/954,788

(22) Filed: Nov. 21, 2024

(30) Foreign Application Priority Data
Nov. 21, 2023 (JP) 2023-197048

(51) Int. Cl. G04C 3/00

(52) U.S. Cl. CPC G04C 3/001; G04C 3/008

(57) ABSTRACT

Disclosed is an electronic device, including: a first metal component and a second metal component that are externally mounted to a case; a first terminal plate that is electrically connected to the first metal component and the second metal component on an outside of the case; and a GND functional section that is provided inside the case and is electrically connected to the first terminal plate.

### CROSS-REFERENCE TO RELATED APPLICATION

This application is based upon and claims the benefit of priority from the prior Japanese Patent Application No. 2023-197048, filed on Nov. 21, 2023, the entire contents of which are incorporated herein by reference.

### TECHNICAL FIELD

The present invention pertains to an electronic device and an electronic timepiece.

### DESCRIPTION OF RELATED ART

Japanese Unexamined Utility Model Application Publication No. S53-62675 describes a switch structure in which an electrically conductive path is, via a zebra connector, formed between a button made from an electrically conductive material to a wiring pattern formed on a circuit board, the button and the wiring pattern formed on the circuit board being caused to be electrically connected through electrically conductive rubber of the zebra connector in accordance with the button being pressed. In addition, recently, there are many electronic devices that are provided with an antenna or the like capable of receiving a GPS signal in order to make a point-in-time correction, or the like.

### SUMMARY

An electronic device according to the present invention is an electronic device, including:
a first metal component and a second metal component that are externally mounted to a case;
a first terminal plate that is electrically connected to the first metal component and the second metal component on an outside of the case; and
a GND functional section that is provided inside the case and is electrically connected to the first terminal plate.

### BRIEF DESCRIPTION OF DRAWINGS

The accompanying drawings are not intended as a definition of the limits of the invention but illustrate embodiments of the invention, and together with the general description given above and the detailed description of the embodiments given below, serve to explain the principles of the invention, wherein:

FIG. 1 is a main-part exploded perspective view of a timepiece according to an embodiment;

FIG. 2 is a front view of the timepiece illustrated in FIG. 1;

FIG. 3 is a main-part cross-sectional view along an III-III line, of the timepiece in FIG. 2;

FIG. 4 is a main-part cross-sectional view along an IV-IV line, of the timepiece in FIG. 2;

FIG. 5 is a side surface view of the timepiece, seen from the direction of an arrow V in FIG. 2;

FIG. 6 is a side surface view of the timepiece, seen from the direction of an arrow VI in FIG. 2;

FIG. 7A is a main-part cross-sectional view along a VIIa-VIIa line in FIG. 5, and FIG. 7B is a main-part cross-sectional view along a VIIb-VIIb line in FIG. 6;

FIG. 8A is a perspective view of a metal bezel in the embodiment, FIG. 8B is a main-part exploded perspective view of a metal button portion according to the embodiment, FIG. 8C is a perspective view of a metal button pipe that is illustrated in FIG. 7B, and FIG. 8D is a perspective view of an external terminal plate in the embodiment;

FIG. 9 is an enlarged cross-sectional view of an IX portion surrounded by a dashed-dotted line in FIG. 3;

FIGS. 10A and 10B are enlarged cross-sectional views of an X portion surrounded by a dashed-dotted line in FIG. 7A, FIG. 10A illustrating a state in which a load is not applied to a metal bezel, and FIG. 10B illustrating a state in which a load is applied to the metal bezel;

FIG. 11 is a plan view of a back cover in the embodiment;

FIG. 12 is a main-part exploded perspective view of the back cover that is illustrated in FIG. 11;

FIG. 13 is a main-part perspective view of a piezoelectric sound-generating unit in an embodiment;

FIG. 14 is a main-part cross-sectional view along an XIV-XIV line, of the back cover in FIG. 11;

FIG. 15 is a perspective view of an internal terminal plate in the embodiment;

FIG. 16 is an enlarged cross-sectional view of an XVI portion surrounded by a dashed-dotted line in FIG. 4; and

FIG. 17 is an enlarged cross-sectional view that illustrates an example in which an internal terminal plate according to one modified example has been applied to the same portion illustrated in FIG. 16.

### DETAILED DESCRIPTION

With reference to the drawings, description is given regarding one embodiment of an electronic device (electronic timepiece) according to the present invention. In the present embodiment, description is given by taking as an example a case where the electronic device (electronic timepiece) is a wristwatch (referred to below as simply a “timepiece 100”), which is used by being worn on a user's arm.

Note that various limitations that are technically desirable in order to carry out the present invention are added to an embodiment that is described below, but the scope of the present invention is not limited to the following embodiment or illustrated examples.

### [Configuration]

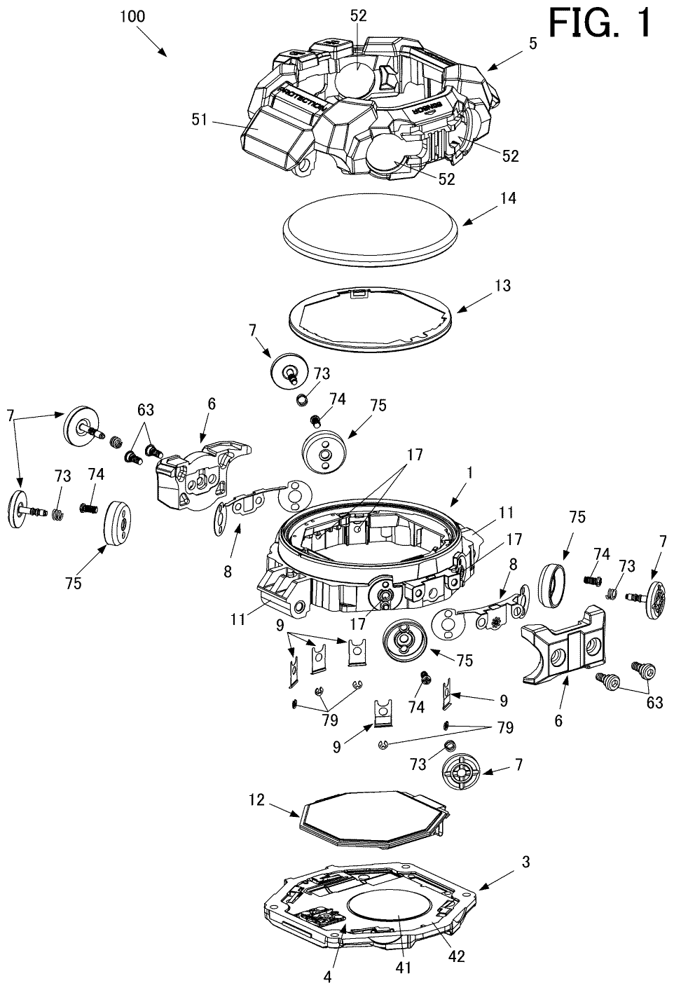

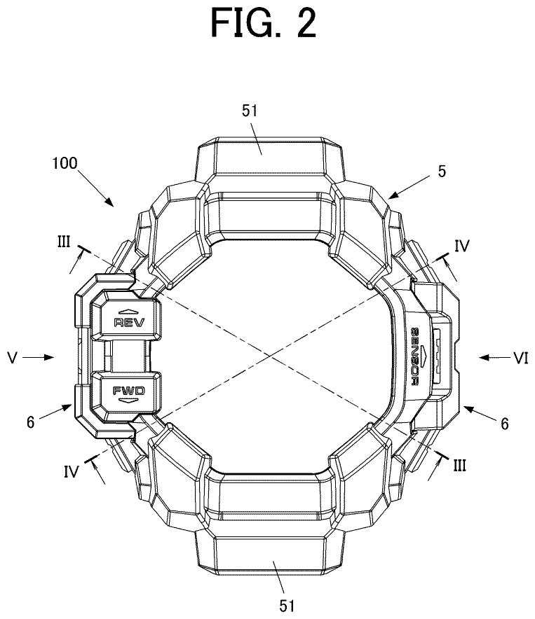

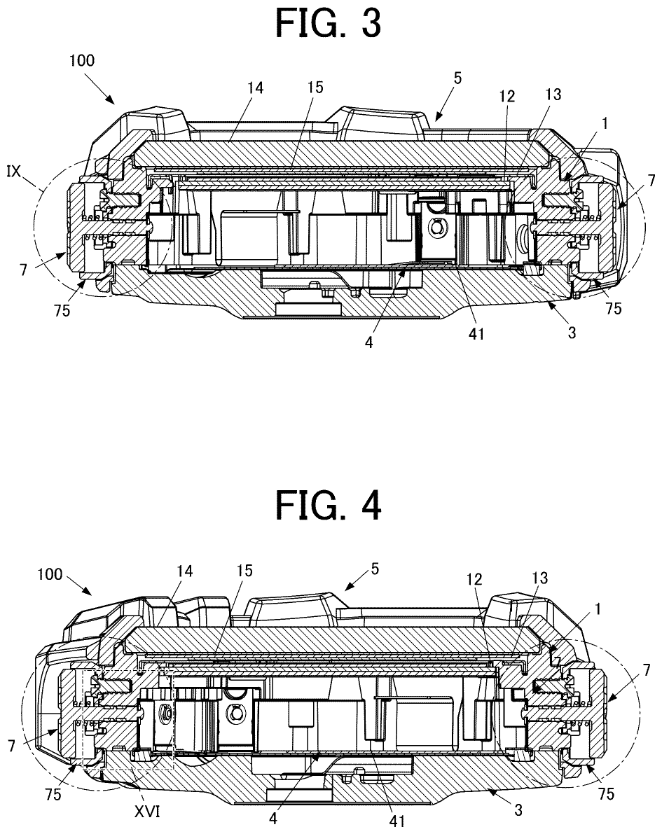

FIG. 1 is a main-part exploded perspective view of a timepiece that is an electronic device (electronic timepiece) in the present embodiment. FIG. 2 is a main-part front view of the timepiece illustrated in FIG. 1. FIG. 3 is a main-part cross-sectional view along a III-III line of the timepiece in FIG. 2. FIG. 4 is a main-part cross-sectional view along an IV-IV line of the timepiece in FIG. 2.

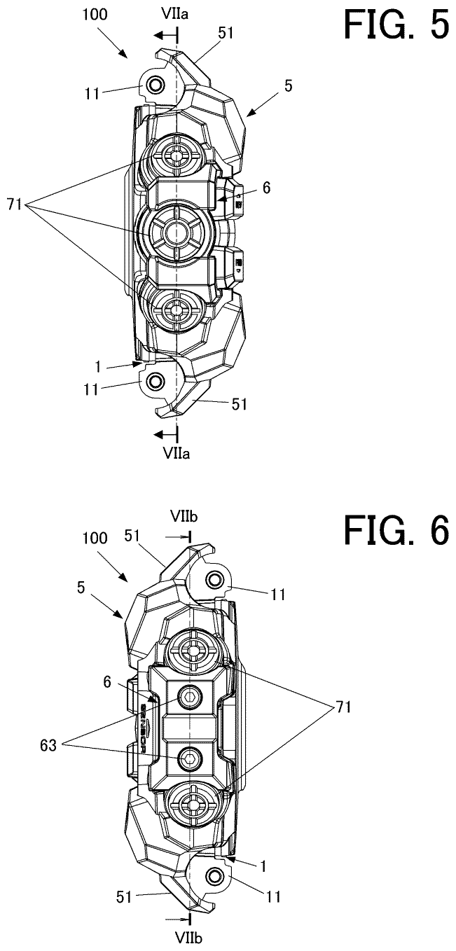

In addition, FIG. 5 is a side surface view on a 9 o'clock side of the timepiece, seen from the direction of an arrow V in FIG. 2. FIG. 6 is a side surface view on a 3 o'clock side of the timepiece, seen from the direction of an arrow VI in FIG. 2.

As illustrated in FIG. 1, the timepiece 100, which is an electronic device (electronic timepiece) in the present embodiment, has a case 1.

The case 1 according to the present embodiment is formed in a hollow, short column shape that is opened at the top and bottom thereof. The internal hollow portion thereof configures a storage space for storing various components.

The case 1 is formed by a relatively hard synthetic resin such as an engineering plastic or a super engineering plastic, for example. Note that material for forming the case 1 is not limited to that exemplified here.

A pair of band attaching sections 11, to which a band (not illustrated) is attached, are provided on the outside surface of the case 1, at a 12 o'clock position and a 6 o'clock position for an analog timepiece.

In addition, metal buttons 7 are provided to the timepiece 100 according to the present embodiment as described below, at a 2 o'clock position, a 4 o'clock position, an 8 o'clock position, a 9 o'clock position, and a 10 o'clock position for an analog timepiece. A through hole 17, through which a shaft 72 for a later-described metal button 7 is to be inserted, is formed in the outside surface of the case 1 at a location corresponding to each metal button 7.

Japanese Unexamined Utility Model Application Publication No. S53-62675 describes a switch structure in which an electrically conductive path is, via a zebra connector, formed between a button made from an electrically conductive material to a wiring pattern formed on a circuit board, the button and the wiring pattern formed on the circuit board being caused to be electrically connected through electrically conductive rubber of the zebra connector in accordance with the button being pressed. In addition, recently, there are many electronic devices that are provided with an antenna or the like capable of receiving a GPS signal in order to make a point-in-time correction, or the like.

When an electrically conductive member that is made from metal or the like is mounted to the outside of an electronic device, there is a problem that the sensitivity of the antenna within the electronic device is affected. In order to stop affecting antenna sensitivity, electrically connecting an electrically conductive member made from a metal or the like to GND (ground) and entering a state in which the difference in potential is zero is required.

However, separately providing an electrically conductive path for electrically connecting each member to GND complicates the configuration of the electronic device, and increases constraints such as the arrangement of members. Regarding this point, Japanese Unexamined Utility Model Application Publication No. S53-62675 does not describe whatsoever a configuration for electrically connecting a plurality of electrically conductive members to GND.

The present invention ameliorates and resolves the problems in such a situation, and enables an electrically conductive path to GND to be ensured collectively in a case where a plurality of electrically conductive members are provided.

As illustrated in FIG. 3 and FIG. 4, an opening portion in a front surface side (visible side for the timepiece, top side in FIG. 3 and FIG. 4) of the case 1 is blocked by a windshield 14. The windshield 14 is a transparent member (a cover) that is formed from a glass material, a transparent resin material, or the like, for example, and is secured to the case 1 by adhesion, for example. A transparent or semitransparent solar panel 15 is overlapped on the windshield 14 and is integrally provided with the windshield 14 (refer to FIG. 3 and FIG. 4) by being adhesively secured, for example. Note that the shape of the solar panel 15, the position where the solar panel 15 is disposed, or the like are not limited to illustrated examples.

An opening portion on the rear surface side of the case 1 (non-visible side for a timepiece, downward in FIG. 3 and FIG. 4) is blocked by a back cover 3. Note that the back cover 3 may be integrally formed with the case 1. The back cover 3 is formed by a metal resin or a hard resin that includes carbon or the like, for example. As a result, it is possible to configure such that the back cover 3 is caused to have high strength, and for the most part not be affected even if the back cover 3 suffers an impact.

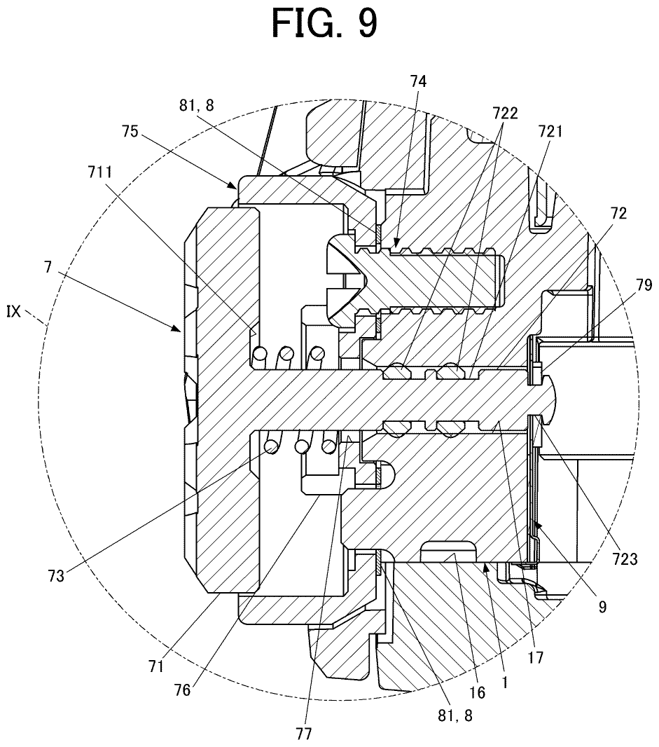

In the present embodiment, a rear surface-side end surface of the case 1 has a recess 16 (refer to FIG. 9) for disposing a waterproofing member such as a waterproof ring (not illustrated). The back cover 3 is attached to the case 1 by a screw (not illustrated), via the waterproofing member. The back cover 3 is attached via the waterproofing member, whereby it is possible to block the opening portion in the rear surface side (non-visible side for a timepiece) of the case 1, in a state where a waterproof property (airtightness) for within the case 1 has been ensured.

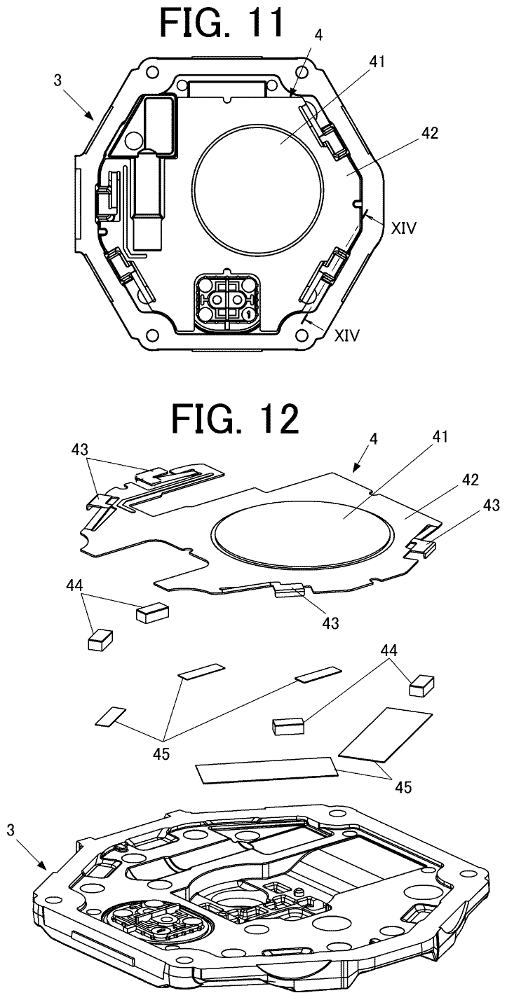

In the present embodiment, a piezoelectric sound-generating unit 4 is disposed inside of the back cover 3 (refer to FIG. 11 and FIG. 12). The piezoelectric sound-generating unit 4 generates a beep sound (sounds a buzzer) to thereby make various alerts to a user or the like, and is a unimorph structure in which a piezoelectric body 41 has been adhered to a diaphragm 42. The diaphragm 42 is a metal plate (sheet metal) that is made from stainless steel (SUS) or the like, for example, and functions as a ground (GND) (may be referred to as a “GND functional section”), as described below. The piezoelectric sound-generating unit 4 is affixed to the inside surface of the back cover 3 using double-sided tape 45 (refer to FIG. 12), for example, and is connected to a circuit board (not illustrated). Note that the diaphragm 42 is not limited to being made from stainless steel (SUS), and may be brass, nickel, or the like.

Detailed illustration and description are omitted, but a controller, an operating section, a battery, and the like for the timepiece 100, which is an electronic device, are stored inside the case 1 (in the storage space described above).

The operating section is a component for the timepiece 100 to perform various displaying. For example, FIG. 1 and the like exemplify a case of a digital display method in which the timepiece 100 is provided with, as the operating section, a display 12 that includes a liquid-crystal display panel or the like. Note that the operating section is not limited to the display 12 that includes a liquid-crystal display panel or the like. For example, in a case of an analog display method, the timepiece 100 has, as the operating section, hands as well as, a driver (such as a motor) or a gear train (a wheel train mechanism) for causing the hands to rotationally operate, in place of various configurations described above. Note that the timepiece 100 may be of a hybrid type having both of the digital method and the analog method. In this case, the timepiece 100 has both components as operating sections.

The controller is mounted onto a circuit board (not illustrated) or the like and controls display operation or the like in accordance with the operating section.

In addition, an antenna 13 is disposed inside the case 1. In the example illustrated in FIG. 1, the antenna 13 is formed in a nearly annular shape, and is disposed, downward or the like of the windshield 14 described previously (refer to FIG. 3 and FIG. 4). Note that the shape of the antenna 13, the position where the antenna 13 is provided, or the like are not limited to illustrated examples. In the present embodiment, the antenna 13 is, for example, a GPS antenna that can receive a GNSS (GPS/GLONASS/QZSS/SBAS) signal transmitted from a GPS satellite or similar kind (includes a plurality of types such as GLONASS in addition to GPS, but is simply referred to as “GPS” below) of satellite.

The GPS satellite is mounted with an atomic clock, and transmits data that includes time information that is in accordance with this atomic clock. A GNSS (GPS) signal or the like that is transmitted from the GPS satellite is received by the antenna 13, whereby it is possible to obtain very highly accurate point-of-time information at any terrestrial receiving location.

In addition, as illustrated from FIG. 1 through FIG. 6, a buffer bezel 5 is provided on the outside of the case 1 according to the present embodiment. The buffer bezel 5 is a buffer that covers nearly the entire side surface of the case 1. Specifically, the buffer bezel 5 is provided so as to surround the opening portion on the front surface side (visible side for the timepiece) of the case 1, and covers nearly the entirety of the side surface of the case 1.

At positions corresponding to the band attaching sections 11 on the case 1, the buffer bezel 5 is provided with coverings 51 in a manner that covers the band attaching sections 11. In addition, an insertion hole 52 that penetrates through the buffer bezel 5 is formed in the buffer bezel 5 in association with each position where a later-described metal button 7 is attached. A material for forming the buffer bezel 5 is not particularly limited, but is formed by a resin such as urethane, for example. Note that it may be that the buffer bezel 5 has a buffering effect and is also formed using a material that is capable of returning to an original shape in a case of being compressed and deformed. The buffer bezel 5 is not limited to a case of being formed by a resin such as urethane.

In addition, a plurality of metal components, which formed from a metal material, are externally mounted to the case 1. Metal components in the present embodiment include metal bezels 6, the metal buttons 7, and metal button pipes 75.

Any of the metal bezel 6, metal button 7, and metal button pipe 75 disposed on the 3 o'clock side illustrated in FIG. 1 is a first metal component, and any of the other metal components different to the first metal component is a second metal component. In addition, an external terminal plate 8 that is disposed on the 3 o'clock side illustrated in FIG. 1 and is electrically connected to the first metal component and the second metal component is a first terminal plate.

Next, any of the metal bezel 6, metal button 7, and metal button pipe 75 disposed on the 9 o'clock side illustrated in FIG. 1 is a third metal component, and any of the other metal components different to the third metal component is a fourth metal component. In addition, an external terminal plate 8 that is disposed on the 9 o'clock side illustrated in FIG. 1 and is electrically connected to the third metal component and the fourth metal component is a second terminal plate.

As illustrated in FIG. 2, and FIG. 5 through FIGS. 7A and 7B, at the side of the case 1 at the 3 o'clock side and the 9 o'clock side for an analog timepiece, the metal bezels 6 are provided in a manner by which the outside of the buffer bezel 5 is covered. The metal bezels 6 are partially disposed outside of the buffer bezel 5, whereby it is possible to improve the external design of the timepiece 100 and give the impression of an air of luxury. Note that the specific shape of the metal bezels 6, and a position, range, or the like for disposing the metal bezels 6 are not limited to the illustrated examples. The metal bezels 6 may be disposed over an even wider range.

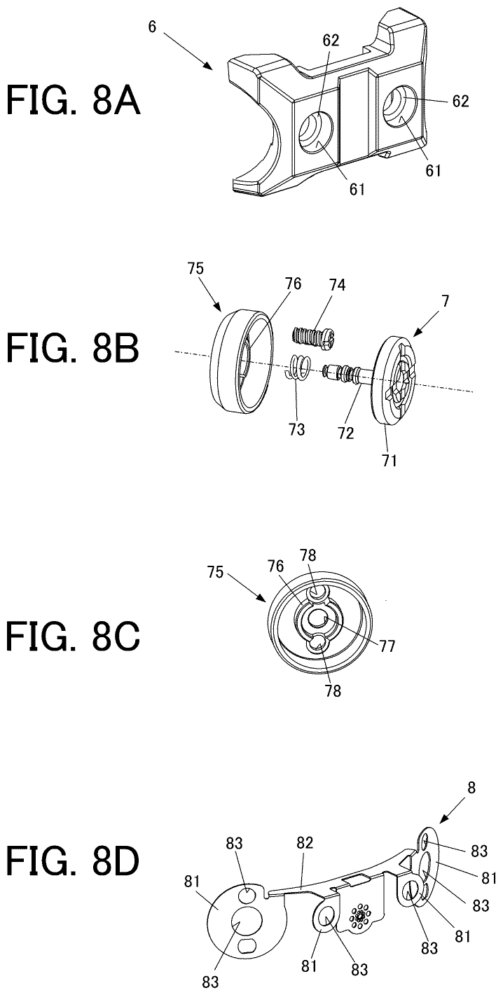

FIG. 8A is a perspective view that illustrates a metal bezel. In FIG. 8A, the metal bezel 6 disposed at the 3 o'clock side for an analog timepiece is illustrated as an example.

In the illustrated example, the metal bezel 6 is screwed in at two locations, and a screw hole 61 is formed at each location where the screwing in is performed.

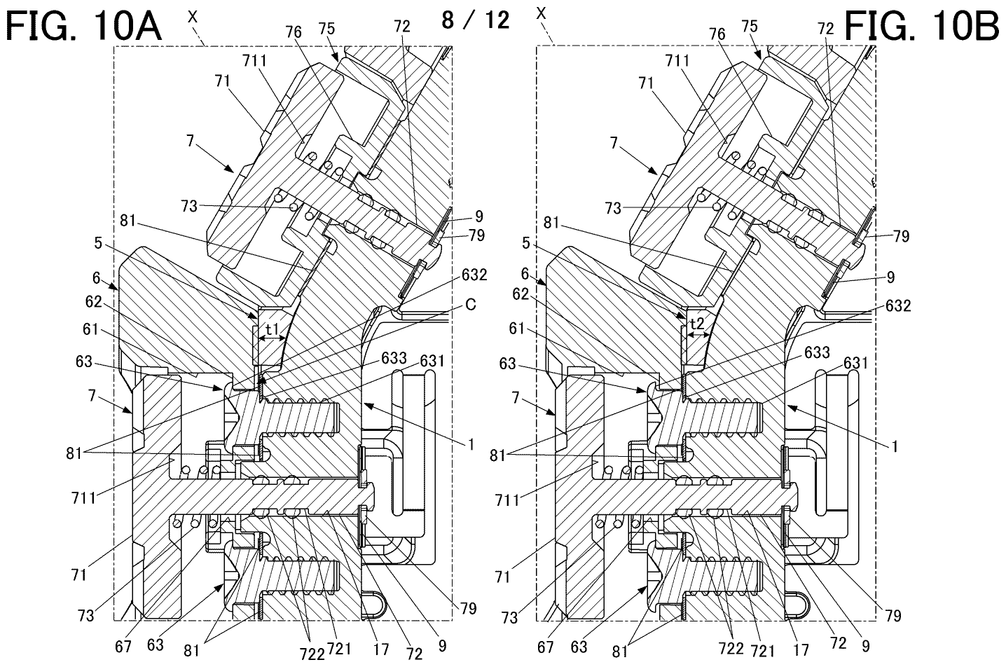

As described below, each metal bezel 6 in the present embodiment is locked to the case 1 by a stepped screw 63 (refer to FIG. 10A and FIG. 10B). As illustrated in FIG. 8A, an abutment surface 62 that a first step 632 of the stepped screw 63 abuts is provided inside each screw hole 61 formed in the metal bezel 6.

In addition, metal buttons 7 are provided to the timepiece 100 according to the present embodiment at a 2 o'clock position, a 4 o'clock position, an 8 o'clock position, a 9 o'clock position, and a 10 o'clock position for an analog timepiece. Each metal button 7 is provided, on its outer circumference, with a metal button pipe 75, which is a metal component.

FIG. 8B is an exploded perspective view of a metal button, and FIG. 8C is a perspective view of a metal button pipe.

As illustrated in FIG. 8B, each metal button 7 is provided with a button head 71 and a shaft 72. The button head 71 is a portion that is exposed outside of the timepiece 100 and is operated by a user. One end side of the shaft 72 is connected to the button head 71, and the other end side is inserted into an insertion hole 77 (refer to FIG. 8C) in the metal button pipe 75 in a state of having been inserted into a coil spring 73. Furthermore, the other end side of the shaft 72 is inserted inside the case 1 via the insertion hole 52 in a buffer bezel 5 and a through hole 17 in the case 1. In the present embodiment, in addition to the metal button pipe 75, the button head 71 and shaft 72 are also metal components that are formed by a metal material.

As illustrated in FIG. 8C, the metal button pipe 75 is a nearly cylindrical member that has a bottom, and has the insertion hole 77 nearly at the center of the bottom thereof. Around the insertion hole 77, a cylinder 76, which is nearly concentric with the insertion hole 77 in plan view, is erected within the metal button pipe 75 from the bottom thereof. When the shaft 72 of the metal button 7 is inserted within the insertion hole 77, one end side of a coil spring 73 is disposed within the cylinder 76. A recess 711 around the shaft 72 is formed on the rear surface side of the button head 71 of the metal button 7 (refer to FIG. 9 or the like). The other end side of the coil spring 73 is disposed within the recess 711. As a result, the metal button pipe 75 and the button head 71 of the metal button 7 are connected via the coil spring 73 and are electrically connected.

In addition, screw holes 78 are formed near the insertion hole 77 at the bottom of the metal button pipe 75. As illustrated in FIG. 1, a positioning pin is formed on the case 1, more on the back cover 3 side than the through hole 17. Accordingly, before screws 74 that are fasteners are inserted into screw holes 78, the positioning pin formed on the case 1 is inserted into one screw hole 78 from among two screw holes 78 in the metal button pipe 75. Screws 74, which are fasteners, are inserted into the screw holes 78, whereby the metal button pipe 75 is fastened to the case 1.

Furthermore, the timepiece 100 has, outside of the case 1, a terminal plate (referred to as an “external terminal plate 8” below) to which a plurality of metal components are connected. The metal button pipes 75 and the metal bezels 6, which are the plurality of metal components, are attached to the case 1 with the external terminal plate 8 interposed therebetween. Specifically, metal bezels 6 and metal button pipes 75 are appropriately disposed via the external terminal plate 8 from outside of the buffer bezel 5, which is attached so as to cover the outside of the case 1, and fastened to the case 1 by fasteners (the stepped screws 63 that are fasteners for fastening the metal bezel 6, and the screws 74 that are fasteners for fastening the metal button pipes 75).

The external terminal plate 8 is formed by a metal material and, as illustrated in FIG. 8D, has a component receiver 81 that is a planar portion for receiving a metal bezel 6 or a metal button pipe 75, and a connecting arm 82 for connecting component receivers 81 to one another. Each component receiver 81 is provided with screw holes 83 for the insertion of stepped screws 63 for securing a metal bezel 6 or the insertion of screws 74 for securing a metal button pipe 75.

The stepped screws 63 and the screws 74 secure the metal bezel 6 or metal button pipe 75 to the case 1 with the external terminal plate 8 interposed therebetween. In other words, the metal bezel 6 and the metal button pipe 75 are both fastened to the case 1 together with the external terminal plate 8. The metal bezels 6 and the metal button pipes 75, which are a plurality of metal components, are fastened together with the external terminal plate 8, whereby an electrical connection via the external terminal plate 8 between members that are fastened via the same external terminal plate 8 (in other words, the metal bezels 6 and the metal button pipes 75) is addressed. In addition, in the present embodiment, the metal button pipe 75 and the button head 71 of the metal button 7 are also in contact with each other via the coil spring 73 as described above. Accordingly, in a case where the button head 71 is a metal component that is formed by a metal material, an electrical connection between the button head 71 and other metal components fastened via the same external terminal plate 8 is addressed. In this manner, the metal button 7 is electrically connected to the external terminal plate 8 via the coil spring 73 and the metal button pipe 75.

FIG. 3, which is a cross-sectional view along the III-III line in FIG. 2, illustrates metal buttons 7 at the 4 o'clock position and the 10 o'clock position surrounded by dashed-dotted lines. FIG. 4, which is a cross-sectional view along the IV-IV line in FIG. 2, illustrates metal buttons 7 at the 2 o'clock position and the 8 o'clock position surrounded by dashed-dotted lines. In each figure, the configuration of each metal button 7 illustrated surrounded by a dashed-dotted line and the periphery is nearly the same.

From among this, FIG. 9 is a main-part enlarged cross-sectional view of an IX portion surrounded by a dashed-dotted line in FIG. 3.

The metal button 7 illustrated in FIG. 9 or the like is a push button that operates by a user pushing the button head 71 whereby the shaft 72 is pushed inside. The button head 71 can move along the axis of the shaft 72 within the metal button pipe 75. The coil spring 73 is disposed between the button head 71 and the metal button pipe 75 as described above. Therefore, when the button head 71 is pushed, the coil spring 73 is compressed. When the pressing force is released, there is push-back due to the restoring force of the coil spring 73, whereby the button head 71 returns to the original position thereof.

As illustrated in FIG. 9, grooves 721 are formed in the shaft 72 in a portion that is inserted within the case 1. Waterproof rings 722 are mounted within the grooves 721. The number, shape, arrangement, or the like of the waterproof rings 722 are not limited to the illustrated examples.

The outer circumferential surface of each waterproof ring 722 is in pressure contact with the inner circumferential surface of a through hole 17 formed in the case 1, and slides within the through hole 17 in response to operation of the metal button 7. As a result, waterproofing between the shaft 72 and the through hole 17 is addressed.

In addition, a groove 723 is formed near the tip of the shaft 72, around the shaft. The shaft 72 is disposed such that, when the shaft 72 is inserted into the through hole 17, at least the tip side that is beyond the groove 723 protrudes within the case 1. A retainer 79 is attached to the groove 723. The shape or the like of the retainer 79 is not limited to the illustrated example, but, for example, an E ring or the like is employed as the retainer 79 that is fitted into the groove 723.

The retainer 79, which is fitted into the groove 723, abuts the inner circumferential surface of the case 1 in a manner that enables the retainer 79 to come into contact and separate from the inner circumferential surface. The retainer 79 abuts the inner circumferential surface of the case 1, whereby the shaft 72 of the metal button 7 is configured such that a tip side portion beyond the groove 723 to which the retainer 79 is attached does not escape to the outside of the case 1.

As described above, the metal button pipe 75 is fastened together with the external terminal plate 8 to the case 1 by screws 74 in a state where the external terminal plate 8 is interposed between the metal button pipe 75 and the outer circumferential surface of the case 1. Note that although only a component receiver 81 from among the external terminal plate 8 appears in the cross-section illustrated in FIG. 9, as described above, the external terminal plate 8 is connected to a plurality of metal components by a plurality of component receivers 81 being connected by the connecting arm 82.

The tip side portion beyond the groove 723 in the shaft 72 of the metal button 7 is in contact with one end side of an internal terminal plate 9, which is described below. As described above, a plurality of metal components (the metal bezels 6, metal buttons 7, and metal button pipes 75 in FIG. 1) are connected to the external terminal plate 8. Each metal component from among the plurality of metal components (the metal bezels 6, metal buttons 7, and metal button pipes 75 in FIG. 1) is electrically connected to (directly or indirectly in contact with) the internal terminal plate 9. When the other end side of the internal terminal plate 9 comes into contact with the diaphragm 42 that serves as a GND functional section, all of the plurality of metal components (the metal bezels 6, metal buttons 7, and metal button pipes 75 in FIG. 1) that are connected to the external terminal plate 8 are electrically connected to GND, and the difference in potential with respect to GND becomes zero. In a case where the back cover 3 is resin (even if the back cover 3 includes carbon), the GND functional section becomes the metal diaphragm 42. However, in a case where the back cover 3 is metal, the GND functional section can be set to the back cover 3. Note that description in detail is given below regarding a configuration in which the metal button 7, which includes the metal button pipe 75 that is a metal component, indirectly comes into contact with the diaphragm 42 that serves as a GND functional section.

In addition, as illustrated in FIG. 2, metal bezels 6 are provided outermost on the timepiece 100 according to the present embodiment at the 3 o'clock side and the 9 o'clock side. Accordingly, the external design is excellent, but when a large impact is applied from the 3 o'clock side or the 9 o'clock side due to the timepiece 100 being dropped or the like, this impact directly acts on the case 1 or various precision components inside the case 1, and there is a risk of adverse effects being imparted. Accordingly, in the present embodiment, an impact-absorbing structure such as the following is provided at a portion where a metal bezel 6 is provided.

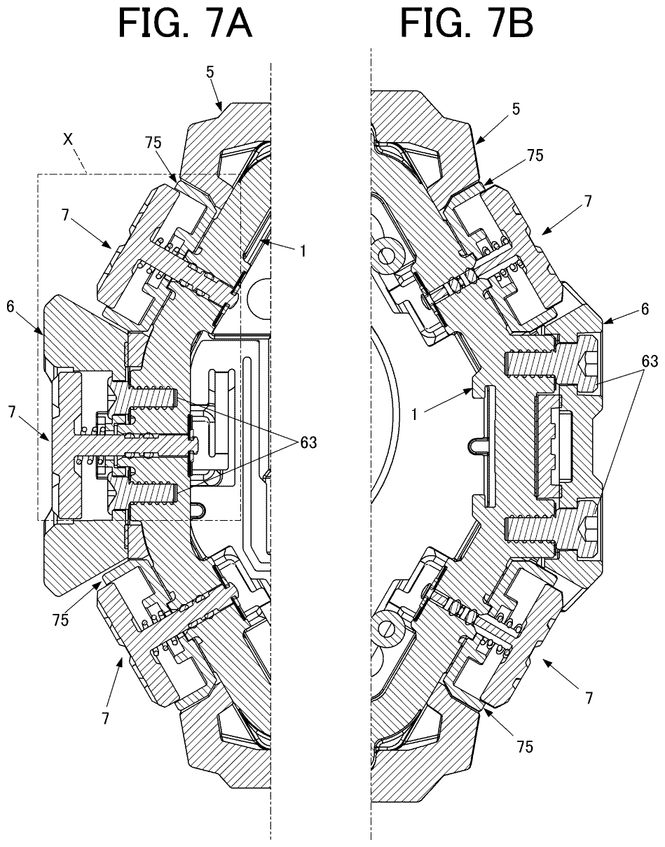

FIG. 10A and FIG. 10B are enlarged cross-sectional views of an X portion surrounded by a dashed-dotted line in FIG. 7A. Note that the impact-absorbing structure for a portion where a metal bezel 6 is provided is also similar on the 3 o'clock side (in other words, the side illustrated in FIG. 7B). In addition, the configuration of the metal button 7 at a portion where the metal bezel 6 is provided is similar to that described in relation to FIG. 9, except that the shaft 72 is inserted into the case 1 by being inserted into an insertion hole 67 of the metal bezel 6 in place of the insertion hole 77 in the metal button pipe 75. Accordingly, description is omitted, stopping at illustration here.

FIG. 10A illustrates a state in which a load is not being applied to a metal bezel.

As described above, each metal bezel 6 is fastened to the case 1 by stepped screws 63. Specifically, the abutment surface 62 that the first step 632 of a stepped screw 63 abuts is provided inside a screw hole 61 in the metal bezel 6. When the stepped screw 63 is fastened, a lower-side surface (right-side surface in FIG. 10A) of the first step 632 abuts against the top surface of the abutment surface 62 (left-side surface in FIG. 10A). As a result, the metal bezel 6 is electrically connected to the stepped screw 63.

In addition, a second step 633 of the stepped screw 63 is in contact with the external terminal plate 8 (component receiver 81 of the external terminal plate 8). The stepped screw 63, as a fastener, fastens the metal bezel 6 and the external terminal plate 8 together with the case 1, in a state where the external terminal plate 8 (component receiver 81 of the external terminal plate 8) is interposed between the metal bezel 6 and the case 1.

In the present embodiment, a buffer bezel 5, which serves as a buffer, is disposed between the case 1 and the metal bezel 6. As illustrated in FIG. 10A, the thickness of the buffer bezel 5 in a state where a load is not being applied to the metal bezel 6 is referred to as a “thickness t1”. In addition, at this point, a gap C as a movable space that can absorb displacement of the metal bezel 6 is provided between the case 1 and the metal bezel 6, which is an exterior. What level to set the “thickness t1” of the buffer bezel 5 and the gap C that corresponds to a movable space can be set, as appropriate.

In contrast to this, FIG. 10B illustrates a state in which a load is being applied to a metal bezel.

When an impact is applied to the metal bezel 6, which is an exterior, due to the timepiece 100 being dropped or the like, the metal bezel 6 is pressed toward the case 1, and displaces. At this point, the metal bezel 6 can move only by an amount equal to the gap C. The buffer bezel 5 is squashed by the amount by which the metal bezel 6 moved. Accordingly, in a state where a load is being applied to the metal bezel 6, the thickness of the buffer bezel 5 becomes a “thickness t2”, which is thinner than the “thickness t1” for when a load is not being applied. In addition, the gap C decreases in accordance with the amount of movement by the metal bezel 6. The illustrated example illustrates a state in which the metal bezel 6 has moved to a level at which the gap C nearly ceases to be.

When the metal bezel 6 displaces to the case 1 side, the abutment surface 62 of the metal bezel 6 separates from the first step 632 of the stepped screw 63. Accordingly, while separated, a state is entered in which the metal bezel 6 is not electrically connected, but when the state in which a load is being applied to the metal bezel 6 stops (in other words, when the impact lessens), the buffer bezel 5 returns to the original shape thereof. As a result, the metal bezel 6 is pushed up to the original position thereof, the first step 632 of the stepped screw 63 again abuts the abutment surface 62 of the metal bezel 6, and an electrically connected state is restored.

In addition, FIG. 11 is a plan view of a back cover in the embodiment, and FIG. 12 is a main-part exploded perspective view of the back cover illustrated in FIG. 11. As described above, the piezoelectric sound-generating unit 4 is affixed to the inside surface of the back cover 3 using double-sided tape 45 or the like.

FIG. 13 is a main-part perspective view of a piezoelectric sound-generating unit.

In the present embodiment, the diaphragm 42 of the piezoelectric sound-generating unit 4 is a metal plate (GND functional section) that functions as GND.

As illustrated in FIG. 13, the diaphragm 42 has spring-shaped sections 43 at some or all positions that correspond to internal terminal plates 9.

Each spring-shaped section 43 has a leaf spring shape, resulting from bending a portion of the diaphragm 42 toward the back surface thereof into an approximate L shape. An elastic body 44 is disposed on the back surface side of the spring-shaped section 43 (between the back cover 3 and the spring-shaped section 43). The elastic body 44 is a supporter for generating a load that is necessary at the spring-shaped section 43.

In other words, each spring-shaped section 43 is provided in order to stably receive an end of an internal terminal plate 9 when the internal terminal plate 9 is disposed. The elastic body 44 ensures necessary contact pressure, and stabilizes contact resistance with respect to the internal terminal plate 9.

The elastic body 44 is affixed to the back surface of the spring-shaped section 43 by double-sided tape or the like. For example, high-performance urethane foam such as a microcell polymer sheet (for example, “PORON” (registered trademark) made by Rogers Inoac Co. or the like) is suitably used as the elastic body 44. Note that it is sufficient if the elastic body 44 is able to stabilize a load on the spring-shaped section 43, and the material of the elastic body 44 is not particularly limited. For example, the elastic body 44 may be a coil spring or the like.

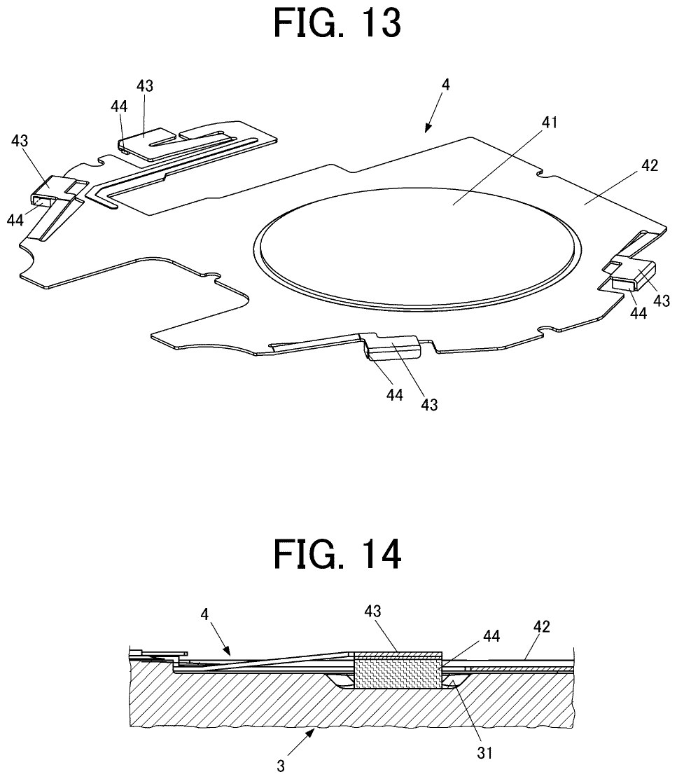

FIG. 14 is a main-part cross-sectional view along an XIV-XIV line, of the back cover in FIG. 11.

As illustrated in FIG. 14 or the like, a recess 31, which is for disposing an elastic body 44 that is provided on the back surface of a spring-shaped section 43, is formed on the inside surface of the back cover 3 at a position that corresponds to the spring-shaped section 43, whereby the elastic body 44 is stably disposed.

Note that it is desirable for the spring-shaped sections 43 to be respectively provided in accordance with the position of each metal button 7. As a result, it is possible to cause the internal terminal plate 9, which is in contact with the shaft 72 of each metal button 7, to reliably be in contact with and be electrically connected to the diaphragm 42 that serves as a GND functional section.

However, although an internal terminal plate 9 is provided in accordance with the metal button 7, there are cases where it is not possible to provide a spring-shaped section 43 at a position that corresponds to the internal terminal plate 9 due to an arrangement situation or the like for various components stored within the case 1.

In the present embodiment, a state is entered in which a plurality of metal components (a metal bezel 6 and metal button pipes 75) are connected to one external terminal plate 8, and are jointly fastened to the case 1. Accordingly, for example, even in a case where there is a location where it is not possible to dispose a spring-shaped section 43 at a position that corresponds to an internal terminal plate 9, if it is possible to reliably connect, to the diaphragm 42, any one internal terminal plate 9 that corresponds to another metal component connected to the same external terminal plate 8, then it is possible to electrically connect all metal components that are connected to this external terminal plate 8 to the diaphragm 42 that serves as a GND functional section, and it is possible to enter a state in which there is zero difference in potential with respect to GND.

The timepiece 100 according to the present embodiment is provided with five metal buttons 7 and is provided with internal terminal plates 9 that respectively correspond thereto, but FIG. 12 and FIG. 13 exemplify a case in which spring-shaped sections 43 are provided at four locations on the diaphragm 42 in accordance with four of these internal terminal plates 9.

FIG. 15 is a perspective view of an internal terminal plate in an embodiment.

The internal terminal plate 9 causes a metal bezel 6 or a metal button pipe 75, which are metal components, to come into contact with and be electrically connected to the diaphragm 42, which is a metal plate that functions as GND.

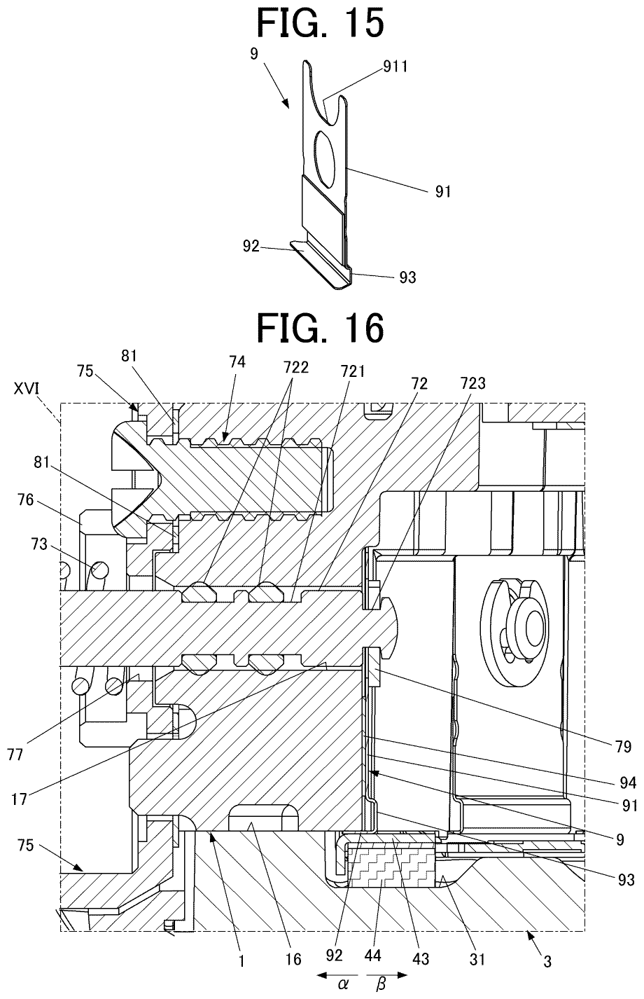

As illustrated in FIG. 15, an internal terminal plate 9 according to the present embodiment has a first site 91 that is connected to a metal component and a second site 92 that is bent in a first direction α (refer to FIG. 16) from a lower end side of the first site 91, and is formed in an approximate L shape in a side surface view. As illustrated in FIG. 16, the first direction α in the present embodiment is toward outside from inside the case 1.

A curved section 911, which is formed at the upper end (free end) of the first site 91, receives the tip end of the shaft 72 of the metal button 7 and comes into contact with this. In addition, a surface of the second site 92 is in contact with the diaphragm 42 (specifically, the spring-shaped section 43 formed integrally with the diaphragm 42) that is a metal plate. Because the spring-shaped section 43 is pushed up by the elastic body 44, the location where the spring-shaped section 43 is provided makes contact in a manner of receiving the second site 92 from the diaphragm 42 side, whereby the internal terminal plate 9 and the diaphragm 42 can stably come into contact. In addition, double-sided tape 94 is disposed at the first site 91 of the internal terminal plate 9, and the first site 91 of the internal terminal plate 9 is affixed to the case 1 via the double-sided tape 94.

In particular, the diaphragm 42 of the piezoelectric sound-generating unit 4 is comparatively thin due to the purpose of causing the piezoelectric body 41 to vibrate. It is difficult to generate a desired load merely by providing the spring-shaped section 43, which has a leaf spring shape. Furthermore, in a case where the piezoelectric sound-generating unit 4 is provided on the back cover 3 as in the present embodiment, poor contact is more likely to occur due to repeated opening and closing, and a contact resistance value will not stabilize (is likely to change) even if contact and an electrical connection are achieved. On this point, a configuration in which an elastic body 44 is provided on the back surface of a spring-shaped section 43 such that the spring-shaped section 43 is pushed up by the elastic body 44 is achieved, whereby it is possible to ensure required contact pressure with respect to the internal terminal plate 9, and electrically connect the internal terminal plate 9 and the diaphragm 42 in a reliable manner. In addition, even if opening and closing is repeated, the spring-shaped section 43 is less likely to suffer wear, and it is possible to maintain stable contact resistance for a long amount of time. As a result, it is possible to stabilize the resistance value of GND, and address strengthening GND.

In addition, the internal terminal plate 9 in an embodiment has a bent section 93 that has a nearly reverse L shape in a side surface view and juts out due to a lower end side of the first site 91 being bent in a second direction β (refer to FIG. 16) opposite to the first direction α. The second site 92 is formed by being bent in the first direction α from the lower end side of the bent section 93.

The internal terminal plate 9 is first bent in the second direction β, caused to bulge in the inside direction for the case 1, and then bent in the first direction α to achieve the second site 92, whereby it is possible to ensure the length of the second site 92 in the first direction α. Accordingly, even if consideration is given to a bending radius or the like for making a bend in the first direction α, it is possible to sufficiently ensure the length of the second site 92, and it is possible to widen the area by which the internal terminal plate 9 and the diaphragm 42 come into contact to thereby have stable contact and electrical connection therebetween.

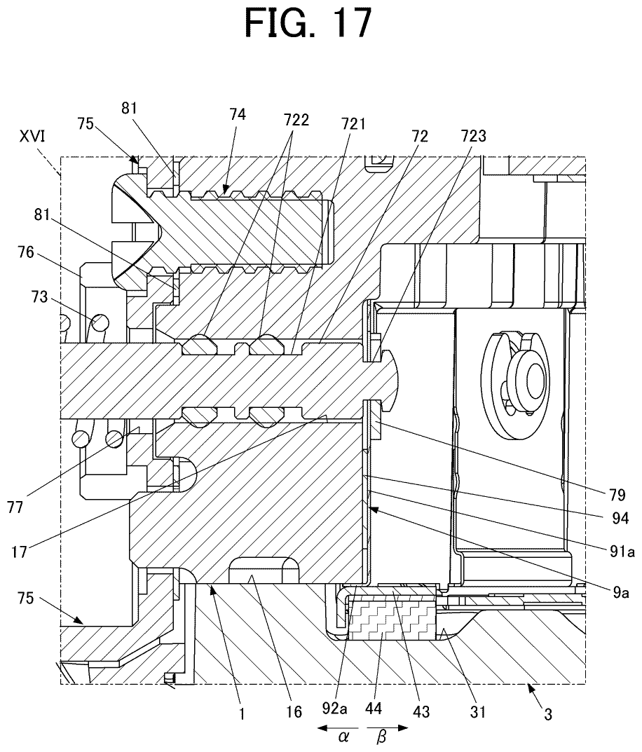

Note that the configuration of the internal terminal plate 9 is not limited to that exemplified here. For example, it may be that an internal terminal plate is an internal terminal plate 9a, which lacks a bent section 93 that is bent in the second direction β. As illustrated in FIG. 17, the internal terminal plate 9a is formed in an approximate L shape in a side surface view and is configured by a first site 91a and a second site 92a that is bent in the first direction α from the lower end side of the first site 91a.

Even in this case, for the internal terminal plate 9a, the second site 92a is formed by being bent in the first direction α at the lower end side of the first site 91a. Therefore, bending, which is sheet metal processing that utilizes the ductility of metal, is used to form a rounded shape (bending radius) at a bend angle between the first site 91a and the second site 92a. Accordingly, the distance by which the internal terminal plate 9a is separated from the case 1 is for this bending radius, but thicker double-sided tape 94 for affixing the first site 91a to the case 1 is employed to thereby make adjustments such that a gap for the bending radius that arises between the first site 91a and the case 1 is filled in.

FIG. 16 is an enlarged cross-sectional view of an XVI portion surrounded by a dashed-dotted line in FIG. 4.

As illustrated in FIG. 16, the first site 91 of the internal terminal plate 9 is disposed at a position for coming into contact with the tip side of the shaft 72 of the metal button 7. In addition, for the internal terminal plate 9, the second site 92 is formed by first being bent in the second direction β on the lower end side and subsequently being bent in the first direction α, and this second site 92 comes into surface contact with the diaphragm 42 (spring-shaped section 43 of the diaphragm 42). More specifically, the second site 92 comes into surface contact with a spring-shaped section 43 that is integrally formed with the diaphragm 42. As a result, the internal terminal plate 9 is electrically connected in a stable manner to the diaphragm 42, which is a metal plate.

The shaft 72 of the metal button 7 is directly or indirectly in contact with the metal button pipe 75, which is a metal component. The internal terminal plate 9 that is in contact with the shaft 72 is caused to come into contact with the diaphragm 42 that functions as GND, whereby it is possible to ensure a conductive path with respect to GND for the metal button pipe 75 and the plurality of metal components connected to the same external terminal plate 8 as the metal button pipe 75, which are collectively electrically connected to GND. As a result, it is possible to address strengthening GND.

Note that the case 1 has a recess 16 for disposing a waterproof (waterproof member) on a back-surface-side end surface, but, as illustrated in FIG. 16, the internal terminal plate 9 and the diaphragm 42 that is a metal plate are both disposed in a region (region that is more inside the case 1 than the recess 16) that does not overlap with this recess 16. Accordingly, a waterproof property between the back cover 3 and the case 1 is not inhibited.

### [Action]

In a case of assembling the timepiece 100 according to the present embodiment, a movement is stored within the case 1, and the opening portion on the visible side is blocked by the windshield 14. In addition, the buffer bezel 5 is disposed so as to cover an outside portion of the case 1, and the metal button pipe 75 (metal button 7 that is attached to the metal button pipe 75) and the metal bezel 6, which are metal components, are attached to the outside of the buffer bezel 5 with the external terminal plate 8 interposed therebetween.

In this case, stepped screws 63 are used to attach the metal bezel 6 to the case 1, and the screws 74 are used to attach the metal button pipe 75 to the case 1. Screwing in is performed in a state where the external terminal plate 8 is interposed between the plurality of metal components and the case 1 in this manner, whereby the external terminal plate 8 and the plurality of metal components are fastened together with the case 1.

The shaft 72 of the metal button 7 inserted into the insertion hole 77 in the metal button pipe 75 is inserted into a through hole 17 in the case 1, and the tip portion thereof is disposed inside the case 1. In order that the shaft 72 does not escape outside of the case 1, the retainer 79 is attached to the tip end of the shaft 72 that is disposed inside the case 1. In addition, an internal terminal plate 9 is disposed such that the first site 91 is in contact with the tip end of the shaft 72.

When various components are mounted, the opening portion on the non-visible side is blocked by the back cover 3. At this point, a waterproof is disposed within the recess 16 in the case 1 to ensure waterproofing between the back cover 3 and the case 1, and the back cover 3 is screwed in to the case 1.

In a state where the back cover 3 is attached, a spring-shaped section 43 of the diaphragm 42 is disposed below the second site 92 of the internal terminal plate 9. A surface of the second site 92 of the internal terminal plate 9 reliably comes into contact with and is electrically connected to a surface of the spring-shaped section 43, which is pushed up by the elastic body 44. By making contact at surfaces in this manner, it becomes possible to have stable contact and electrical connection that is not impacted by position deviation or the like.

Note that there are cases where a load does not stabilize at a location where a spring-shaped section 43 is not provided, and it is difficult to have a reliable electrical connection to GND at such a location. However, the plurality of metal components are fastened together with the external terminal plate 8 at the outside of the case 1, and are electrically connected to each other. Accordingly, if even one of the plurality of metal components in contact with one external terminal plate 8 is in contact with a spring-shaped section 43, it is possible to collectively electrically connect all of the metal components that are in contact with the external terminal plate 8 to GND, and it is possible to strengthen GND.

As a result, it is possible to ensure a conductive path from the mounted plurality of metal components (metal bezels 6, metal buttons 7, metal button pipes 75, and the like) to the GND (the diaphragm 42 that functions as GND) within the case 1, and reliably ground the plurality of metal components.

The metal components are electrically connected to GND, whereby it is possible to prevent the sensitivity (performance) of the antenna 13 provided inside the timepiece 100 from being affected by the metal components, and it is possible to realize a timepiece 100 that has high reliability in relation to a point-in-time correction or the like using the antenna 13.

In addition, each metal bezel 6 that corresponds to an exterior is attached to the case 1 using stepped screws 63, and the gap C that corresponds to a movable space for allowing movement of the metal bezel 6 is provided between the metal bezel 6 and the case 1. As a result, even in a case where the metal bezel 6 is pushed in due to an impact such as a fall, it is possible to absorb the displacement in the gap C. Furthermore, the buffer bezel 5 that serves as a buffer is disposed between the metal bezel 6 and the case 1, whereby it is possible to absorb/alleviate impacts. Accordingly, there ceases to be a need to perform strengthening by applying various additives to the case 1 itself, and an impact on antenna performance due to additives does not arise.

### [Effect]

The timepiece 100 that is an electronic device in the present embodiment as above is provided with a plurality of metal components, an external terminal plate 8, and the diaphragm 42, the plurality of metal components being the first metal component and the second metal component externally mounted to the case 1, the external terminal plate 8 being a first terminal plate that is electrically connected to the first metal component and the second metal component on the outside of the case 1, and the diaphragm 42 being provided inside the case 1 and serving as a GND functional section that is electrically connected to the external terminal plate 8. As a result, even if a plurality of metal components that are electrically conductive members are externally mounted to the case 1, it is possible to ensure an electrically conductive path from all of the metal components to the diaphragm 42 that serves as GND, and it is possible to enter a state in which there is collectively no difference in potential between the metal components and GND. Accordingly, by a relatively simple configuration, it is possible to constrain effects on a precision device inside an electronic device such as the timepiece 100.

When the timepiece 100 is configured in this manner, particularly as that in the present embodiment, it is possible to realize an external design having an air of luxury by externally mounting various metal components. Even while realizing the air of luxury, it is possible to avoid influencing the sensitivity (performance) of an internal antenna, and realize reception of highly-accurate radio waves, accurate point-in-time correction using the received radio waves, or the like.

In addition, a third metal component and a fourth metal component that differ to the first metal component and the second metal component may be externally mounted to the case 1. In this case, a second terminal plate (external terminal plate 8) that is electrically connected to the third metal component and the fourth metal component is provided on the outside of the case 1, and the GND functional section is also electrically connected to the second terminal plate.

For example, in a case such as where the first metal component, the second metal component, and the first terminal plate are disposed on the 3 o'clock side for the timepiece 100 and the third metal component, the fourth metal component, and the second terminal plate are disposed on the 9 o'clock side for the timepiece 100, it is possible to ensure an electrically conductive path from each metal component to the diaphragm 42 that functions as GND, and it is possible to enter a state in which there is no difference in potential between all externally mounted metal components and GND. As a result, it is possible to address establishing both of an external design that has an air of luxury, and the avoidance of impacting a precision device within the device.

In addition, in the present embodiment, the plurality of metal components (the first metal component and the second metal component) include the metal bezels 6, the metal buttons 7, and the metal button pipes 75. As a result, it is possible to realize an external design that has an air of luxury and for which metal components such as the metal bezels 6, the metal buttons 7, and the metal button pipes 75 are disposed on the exterior. It is possible to enter a state in which metal components collectively have no difference in potential with respect to GND, and it is possible to enter a state in which there is no impact on internal devices, while giving the impression of an air of luxury.

In addition, in the present embodiment, the metal bezels 6 and the metal button pipes 75 from among the plurality of metal components are attached to the case 1 by screws 74 or stepped screws 63, which serve as fasteners, via the external terminal plate 8. As a result, if one of the metal components connected to the same external terminal plate 8 can be stably connected to GND, these metal components can be collectively grounded, and it is possible to reduce the number of components and realize a simple configuration.

In addition, in the present embodiment, each metal button 7 is provided with a button head 71 and a shaft 72, one end side of the shaft 72 being connected to the button head 71 and the other end side thereof being inserted into a coil spring 73, the metal button 7 being electrically connected to an external terminal plate 8 (first terminal plate, second terminal plate) via the coil spring 73 and the metal button pipe 75. As a result, even if a special component is not added, it is possible to use components normally provided to the metal button 7 to address making an electrical connection between the metal button 7 and the external terminal plate 8.

In addition, in the present embodiment, the antenna 13 is provided within the case 1. When an electrically conductive member that is made from metal or the like is mounted to the outside of an electronic device such as the timepiece 100, the sensitivity of the antenna 13 within the electronic device would be affected. In order to stop affecting antenna sensitivity, electrically connecting an electrically conductive member made from a metal or the like to GND, and entering a state in which the difference in potential is zero is necessary.

Regarding this point, in the present embodiment, each external terminal plate 8 that is connected to a plurality of metal components is provided, whereby it is possible to collectively ground the plurality of metal components, even if an individual electrically conductive path is not ensured for each component. As a result, it is possible to constrain effects on the antenna 13 by using a relatively simple configuration, and it is possible to realize highly accurate reception of radio waves.

### [Variation]

Note that description was given above regarding embodiments of the present invention, but the present invention is not limited to these embodiments. It goes without saying that various variations are possible in a range that does not deviate from the substance of the present invention.

In addition, in the present embodiment, description was given for a configuration in which external terminal plates 8 are disposed at the 3 o'clock position and 9 o'clock position for an analog timepiece and are each fastened together with at least one metal bezel 6 and the case 1. However, the position or range at which the external terminal plates 8 are provided as well as the number or type of metal components connected to one external terminal plate 8 are not limited to that exemplified in the embodiment. Even more metal bezels 6 or metal button pipes 75 may be connected to one external terminal plate 8. Even in this case, if any one of the metal components connected by the external terminal plate 8 is electrically connected to GND, it is possible to electrically connect all of the metal components that are connected to the external terminal plate 8 to GND.

Note that metal components in the present embodiment are given as including the metal bezels 6, the metal buttons 7, and the metal button pipes 75, but it may be that metal components are an operation button formed by a different material that is not made of metal, in place of the metal buttons 7, including the metal bezels 6 and metal button pipes 75.

In addition, in the present embodiment, a case in which the buffer bezel 5 that corresponds to a buffer covers nearly the entirety of the case 1 and metal bezels 6 are disposed at the 3 o'clock position and 9 o'clock position for an analog timepiece was exemplified. However, the position or range at which the buffer bezel 5 and the metal bezels 6 are provided are not limited to those described in embodiments.

In addition, in the present embodiment, a case in which the diaphragm 42 of the piezoelectric sound-generating unit 4 is a GND functional section that functions as GND was exemplified, but a GND functional section is not limited to the diaphragm 42 and may be a metallic member that is provided inside the case 1 and is indirectly connected to the external terminal plate 8.

In addition, in the present embodiment, a case in which an electronic device is a wristwatch type timepiece 100 is exemplified, but the electronic device is not limited to this.

For example, it is possible to have wide application to electronic devices such as various kinds of smart watches or sports watches, or electronic devices such as wearable devices for obtaining biological information such as a heartbeat or information regarding the flow of blood in addition to obtaining a point in time.

While some embodiments of the present invention are described above, the scope of the present invention is not limited to the embodiments described above, and includes the scope of the invention set forth in the claims and the scope of their equivalents.

1. An electronic device, comprising:
a first metal component and a second metal component that are externally mounted to a case;
a first terminal plate that is electrically connected to the first metal component and the second metal component on an outside of the case; and
a GND functional section that is provided inside the case and is electrically connected to the first terminal plate.

2. The electronic device according to claim 1, further comprising:
a third metal component and a fourth metal component that are externally mounted to the case; and
a second terminal plate that is electrically connected to the third metal component and the fourth metal component on an outside of the case,
wherein the GND functional section is electrically connected to the second terminal plate.

3. The electronic device according to claim 2, wherein each of the first metal component, the second metal component, the third metal component, and the fourth metal component includes any of a metal bezel, a metal button, and a metal button pipe.

4. The electronic device according to claim 3, wherein
the metal button is provided with a button head and a shaft, one end side of the shaft being connected to the button head and the other end side of the shaft being inserted into a coil spring, and
the metal button is electrically connected to the terminal plate via the coil spring and the metal button pipe.

5. The electronic device according to claim 1, wherein the first metal component and the second metal component are attached to the case using a fastener via the first terminal plate.

6. The electronic device according to claim 2, wherein the first metal component and the second metal component are attached to the case using a fastener via the first terminal plate.

7. The electronic device according to claim 3, wherein the first metal component and the second metal component are attached to the case using a fastener via the first terminal plate.

8. The electronic device according to claim 4, wherein the first metal component and the second metal component are attached to the case using a fastener via the first terminal plate.

9. The electronic device according to claim 2, wherein the third metal component and the fourth metal component are attached to the case using a fastener via the second terminal plate.

10. The electronic device according to claim 6, wherein the third metal component and the fourth metal component are attached to the case using a fastener via the second terminal plate.

11. The electronic device according to claim 1, wherein an antenna is provided within the case.

12. The electronic device according to claim 2, wherein an antenna is provided within the case.

13. The electronic device according to claim 3, wherein an antenna is provided within the case.

14. The electronic device according to claim 4, wherein an antenna is provided within the case.

15. The electronic device according to claim 1, wherein the GND functional section is a diaphragm that is configured from a metal plate.

16. The electronic device according to claim 2, wherein the GND functional section is a diaphragm that is configured from a metal plate.

17. The electronic device according to claim 3, wherein the GND functional section is a diaphragm that is configured from a metal plate.

18. An electronic timepiece comprising:
a first metal component and a second metal component that are externally mounted to a case;
a first terminal plate that is electrically connected to the first metal component and the second metal component on an outside of the case; and
a GND functional section that is provided inside the case and is electrically connected to the first terminal plate.

19. The electronic timepiece according to claim 18, further comprising:
a third metal component and a fourth metal component that are externally mounted to the case; and
a second terminal plate that is electrically connected to the third metal component and the fourth metal component on an outside of the case,
wherein the GND functional section is electrically connected to the second terminal plate.

20. The electronic timepiece according to claim 19, wherein
the first metal component, the second metal component, and the first terminal plate are disposed on a 3 o'clock side, and
the third metal component, the fourth metal component, and the second terminal plate are disposed on a 9 o'clock side.
